(19) United States
(12) Patent Application Publication
(10) Pub. No.: US 2025/0021854 A1
(43) Pub. Date: Jan. 16, 2025

(54) CONTROL DEVICE

(71) Applicant: Hitachi, Ltd., Tokyo (JP)

(72) Inventors: Takanobu TSUNODA, Tokyo (JP); Tomonori SEKIGUCHI, Tokyo (JP)

(21) Appl. No.: 18/582,734

(22) Filed: Feb. 21, 2024

(30) Foreign Application Priority Data
Jul. 11, 2023 (JP) 2023-113522

(51) Int. Cl. G06N 10/20

(52) U.S. Cl. CPC G06N 10/20

(57) ABSTRACT

It is possible to implement a control device for a quantum bit array having high practical utility, that can efficiently hold, with a small number of bits, control parameters necessary for quantum operation in the quantum bit array in which a plurality of quantum bits are arranged. There is provided a control device that controls quantum operation in a quantum bit array in which a plurality of quantum bits are arranged one-dimensionally or two-dimensionally. The control device includes a command memory that stores a plurality of control commands and a parameter memory that stores part or all of control parameters accompanying the control commands. A command format of the control commands includes one or more parameter specifying fields to specify either an immediate value of a control parameter or reference to the control parameter stored in the parameter memory.

### CROSS-REFERENCE TO RELATED APPLICATION

The present application claims priority from Japanese application JP2023-113522, filed on Jul. 11, 2023, the content of which is hereby incorporated by reference into this application.

### BACKGROUND OF THE INVENTION

### 1. Field of the Invention

The present invention relates to a control device.

### 2. Description of the Related Art

It is certainly thought that improvement in the performance through miniaturization of semiconductor elements, which has supported progress of the computer for more than half a century, will reach the limit in the near future from comparison between the process rule and the atomic distance of silicon. The quantum computer is an attempt to overcome the limit by new calculation principle and device, and quantum computation devices and computation systems using a superconducting circuit, an ion trap, photons, silicon quantum dots, and so forth have been proposed. In addition, as a preliminary step toward a future plan that a large-scale, practical application is executed by a general-purpose quantum computer system with error resistance, principle verification and searches for algorithms regarding a system called a noisy intermediate-scale quantum device (NISQ) premised on a concept that the number of quantum bits is as small as approximately 100 and error correction is impossible are being advanced at the current moment.

It is usual to select a dilution refrigerator as a device that becomes an incorporation destination to implement a quantum computer system to which a quantum computation device using, as the computation principle, a quantum effect that appears at an extremely-low temperature like a single electron spin in a silicon quantum dot is applied. In this case, the following configuration just like an experimental device is frequently employed. The quantum computation device is fixed thermally in contact with a mixing chamber in which the temperature lowers to the largest extent in the dilution refrigerator. Furthermore, signals necessary for control of quantum computation device operation are applied from a signal generator disposed outside the dilution refrigerator and a computation result is read out by a measuring machine disposed outside the dilution refrigerator similarly.

### SUMMARY OF THE INVENTION

In JP-1989-169655-A, regarding command acquisition processing of a classical data processing device that does not use the quantum effect, disclosed is a technique in which command codes each stored in a different address area in an external memory and command parameters necessary to execute the command codes are sequentially acquired via one external memory access means. By using this technique, reduction in the implementation cost of an access interface to the external memory can be intended in an embedded microcontroller or the like that is oriented for low power consumption particularly and does not include a built-in read-only memory. Moreover, when a plurality of same command parameter values exist, an effect of reduction in the size of a command parameter area in the read-only memory can be further expected.

In the quantum computer premised on an extremely-low temperature environment implemented by the dilution refrigerator, the power consumption condition permitted for the quantum computation device is severe. In addition, particular restrictions different from restrictions in the classical computer exist. Specifically, a restriction is that wiring lines that connect the inside and the outside of the dilution refrigerator do not only transmit power and signals but also become a medium of thermal conduction, and thus only the minimum number of wiring lines depending on the balance between the target attained temperature of the mixing chamber and the cooling ability of the dilution refrigerator can be laid. Furthermore, a restriction is that these wiring lines are disposed across a long distance, and thus inevitably the transmission speed is also suppressed.

In addition, in the quantum computer, a temporally-discontinuous characteristic change of the quantum computation device attributed to a temperature cycle and continuous temporal variation of control output due to a reason in terms of a circuit characteristic or implementation design of a control device that controls the quantum computation device exist. Due to the influence of these factors, the optimum control parameter values to implement intended quantum operation need to be experimentally decided prior to the primary quantum operation and can also temporally change. Such points are cited as characteristics essentially different from those of the classical computer.

The present invention is made in view of the above-described problem and intends to provide a control device for a quantum bit array having high practical utility, that can efficiently hold, with a small number of bits, control parameters necessary for quantum operation in the quantum bit array in which a plurality of quantum bits are arranged.

A control device according to the present invention is a control device that controls quantum operation in a quantum bit array in which a plurality of quantum bits are arranged one-dimensionally or two-dimensionally. The control device includes a command memory that stores a plurality of control commands and a parameter memory that stores part or all of control parameters accompanying the control commands. A command format of the control commands includes one or more parameter specifying fields to specify either an immediate value of a control parameter or reference to the control parameter stored in the parameter memory.

According to the present invention, it is possible to implement a control device for a quantum bit array having high practical utility, that can efficiently hold, with a small number of bits, control parameters necessary for quantum operation in the quantum bit array in which a plurality of quantum bits are arranged.

### BRIEF DESCRIPTION OF THE DRAWINGS

FIG. 1 is a block diagram illustrating the configuration of a quantum computation system according to a first embodiment;

FIG. 2 is a diagram illustrating a command format;

FIG. 3 is a diagram illustrating one example of command storage in a command memory;

FIG. 4 is a diagram illustrating one example of parameter storage in a parameter memory;

FIG. 5 is a block diagram illustrating the configuration of a sequence control section;

FIG. 6 is a block diagram illustrating the configuration of a calibration control section;

FIG. 7 is a timing chart illustrating one example of a command execution sequence;

FIG. 8A is a diagram illustrating a calibration processing flow;

FIG. 8B is a diagram illustrating a calibration processing flow;

FIG. 9 is a block diagram illustrating the configuration of a quantum computation system according to a second embodiment;

FIG. 10 is a diagram illustrating one example of parameter storage in a calibrated parameter memory;

FIG. 11 is a timing chart illustrating one example of a command execution sequence in the second embodiment;

FIG. 12 is a block diagram illustrating the configuration of a quantum computation system according to a third embodiment;

FIG. 13 is a diagram illustrating one example of parameter storage in a difference parameter memory;

FIG. 14 is a diagram illustrating one example of offset value storage in an offset register file;

FIG. 15 is a block diagram illustrating the configuration of a calibration control section;

FIG. 16 is a timing chart illustrating one example of a command execution sequence in the third embodiment; and

FIG. 17 is a diagram illustrating a calibration processing flow in the third embodiment.

### DESCRIPTION OF THE PREFERRED EMBODIMENTS

The present embodiments will be described below with reference to the accompanying drawings. In the accompanying drawings, the same element in terms of the function is illustrated with the same number or a corresponding number in some cases. The accompanying drawings illustrate embodiments and embodiment examples in conformity with the principle of the present disclosure. However, they are for understanding of the present disclosure and are never used to interpret the present disclosure in a limited manner. The description of the present specification is merely typical exemplification and does not limit the scope of claims or application examples in the present disclosure in any sense.

In the present embodiment, description thereof is made in sufficient detail for those skilled in the art to carry out the present disclosure. However, it should be understood that other implementations and forms are also possible and it is possible to change configurations and structures and replace a wide variety of elements without departing from the scope and spirit of technical ideas of the present disclosure. Therefore, the description made hereinafter must not be interpreted in such a manner as to be limited thereto.

Hereinafter, regarding a gate-type quantum computer system, description will be made about a control device oriented for a quantum device, a control method, and a quantum computer system that efficiently set, with a small number of bits, parameters to control generation and application of a bias voltage and a high frequency necessary for operation of each quantum bit and autonomously calibrate the set values thereof by being combined with a quantum computation device in which a plurality of single electron spin quantum bits are arranged particularly. Furthermore, as one example thereof, description will be made about a configuration including means that efficiently holds control parameters with a small number of bits without referring to an external memory and means that autonomously calibrates the control parameters in response to characteristic variation of a quantum computation device that is a control target, regarding quantum computation device control to implement an intended quantum computation sequence and individual quantum operations. By such a configuration, the control parameters necessary for quantum operation in a quantum bit array in which a plurality of quantum bits are arranged can be efficiently held with a small number of bits. Moreover, a quantum bit array control device, a control method, and a quantum computer system that have high practical utility can be implemented by being combined with a calibration function of autonomously calibrating the control parameters in response to temporal characteristic variation of the control target.

### First Embodiment

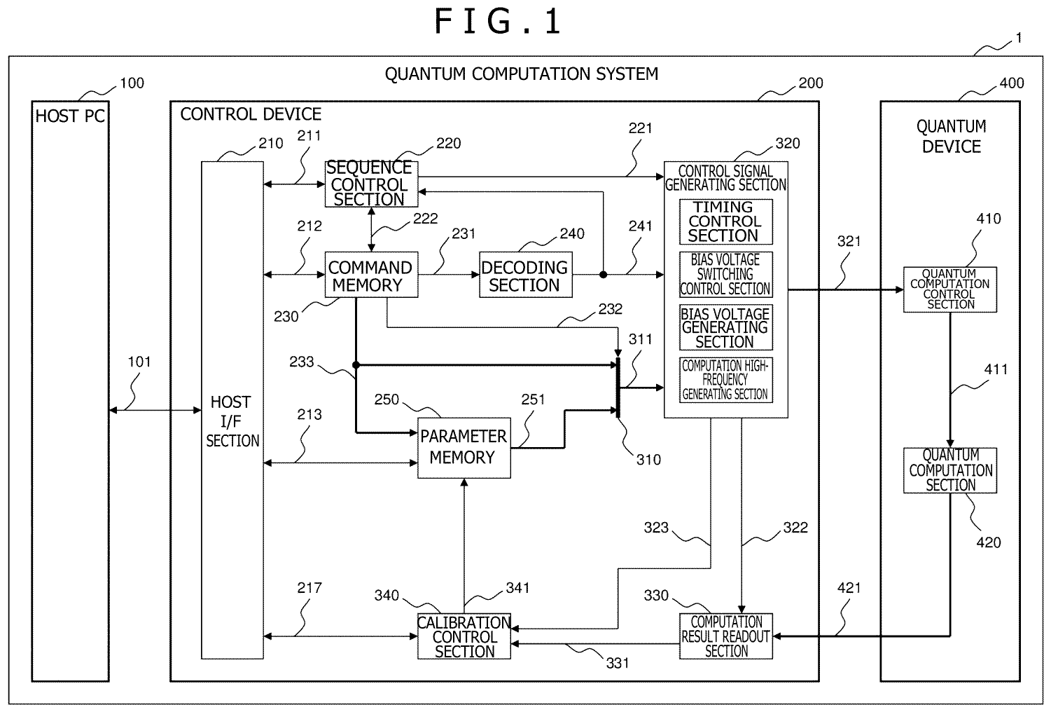

FIG. 1 illustrates the configuration of a quantum computation system 1 according to a first embodiment of the present invention. The present embodiment is obtained by combining a quantum device 400 that executes quantum operation with a host PC 100 that supervises the whole of a quantum computation sequence and a control device 200 that generates a control signal for the quantum device 400 and acquires a computation result on the basis of a command received from the host PC 100, and making them into a system.

The host PC 100 is generally installed in a room temperature environment (for example, 20° C.). Meanwhile, particularly a quantum computation section 420 in the quantum device 400 is disposed in an extremely-low temperature environment (for example, minus 272° C.) implemented by a mixing chamber in which the temperature lowers to the largest extent in a dilution refrigerator, and allows operation of quantum bits. The other configurations are disposed in temperature environments between the room temperature environment and the extremely-low temperature environment. The temperature gradient in this case is generated from the high temperature side toward the low temperature side along the flow of a signal from the host PC 100 toward the quantum computation section 420. For example, a semiconductor chip that configures the quantum device 400 is disposed in the extremely-low temperature environment, and a semiconductor chip that configures the control device 200 is disposed in an environment at a temperature lower than that in the room environment (however, it is not the extremely-low temperature environment in which quantum bits operate). However, when the cooling ability of the mixing chamber is sufficiently high, the control device 200 and the quantum device 400 may be configured by the same semiconductor chip, and the whole thereof may be disposed in the extremely-low temperature environment.

Suppose that the host PC 100 is a general information processing device including microprocessor, memory, storage device, input device, output device, and so forth that are not illustrated, and a system control application that manages overall control of the quantum computation sequence that should be executed in the quantum computation system 1 is operating therein.

The system control application interprets the specified quantum computation sequence and supplies commands and various kinds of control information necessary for quantum computation to the control device 200 through a host interface 101. In addition, the system control application acquires a quantum computation result read out from the quantum device 400. Here, the host interface 101 may be an interface based on a standard communication specification, such as USB (registered trademark), SPI (registered trademark), I2C (registered trademark), RS-232C, PCI Express (registered trademark), or Ethernet (registered trademark), or may be of a unique specification based on a general-purpose input-output port.

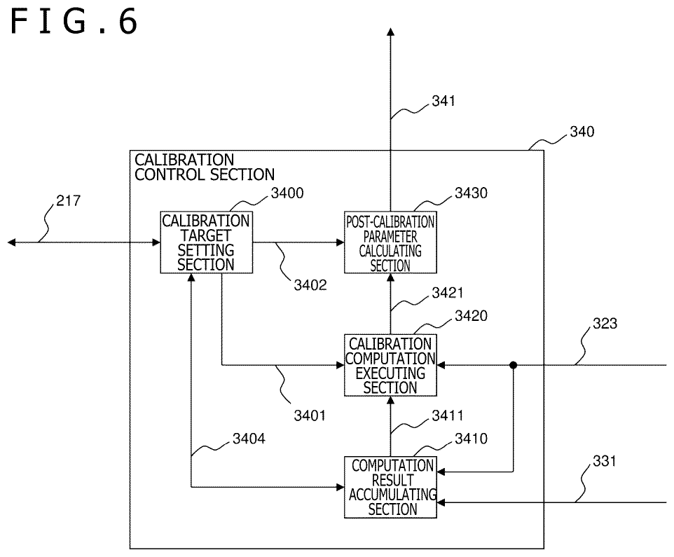

The control device 200 includes a host interface section 210, a sequence control section 220, a command memory 230, a decoding section 240, a parameter memory 250, a quantum device control signal generating section 320, a computation result readout section 330, and a calibration control section 340. Among them, details of the sequence control section 220 and the calibration control section 340 will be described later with reference to FIG. 5 and FIG. 6, respectively.

The host interface section 210 controls communication with the host PC 100 connected by the host interface 101, and mutually converts various control signals with a control interface 211 that controls operation of the sequence control section 220, a control interface 212 that controls access to the command memory 230, a control interface 213 that controls access to the parameter memory 250, and a control interface 217 for controlling operation of the calibration control section 340 and acquiring a quantum computation result accumulated in the calibration control section 340.

Prior to execution start of the quantum computation sequence (command sequence), the host PC 100 stores the command sequence that should be executed in the command memory 230 by the control interface 212 and stores all parameters referenced from the command sequence in the parameter memory 250 by the control interface 213. The system control application that operates on the host PC 100 is responsible for ensuring of consistency relating to parameter reference.

The sequence control section 220 makes a transition to a command executing state when receiving an execution request of the quantum computation sequence (command sequence) stored in the command memory 230 in advance from the control interface 211.

The sequence control section 220 in the command executing state makes an instruction to start execution of one command stored in a specific entry in the command memory 230, specified by an entry number, through a command memory control signal 222. In addition to this instruction, the sequence control section 220 acquires rate information indicating the execution time of the execution-target command as a response signal to the instruction from the command memory 230 through the command memory control signal 222. Furthermore, the sequence control section 220 acquires, from the decoding section 240, information indicating whether or not the execution-target command is the termination (termination command) of the command sequence stored in the command memory 230 as part of decoding result information 241.

When the command in execution is not the termination command, the sequence control section 220 that has waited for the time specified by the rate information until the execution time of the command in execution elapses increments the entry number, and instructs the command memory 230 to start execution of the subsequent command through the command memory control signal 222 anew. When it is the termination command, the command that should be executed does not exist any more. Therefore, the sequence control section 220 makes a transition to the command non-executing state. Whether or not the sequence control section 220 is in the command executing state is always notified to the quantum device control signal generating section 320 by a command executing state signal 221.

The command memory 230 has a memory structure formed from a plurality of entries that can each be identified by the entry number, and stores one command per entry. The command memory 230 reads out the command in the entry specified by the entry number when a command execution request is made from the sequence control section 220 through the command memory control signal 222. The command memory 230 outputs, in computation information 231, information that identifies the contents of operation of the relevant command read out, and outputs the rate information in the command memory control signal 222. The command memory 230 outputs, in an external parameter selection signal 232, information that specifies the reference source (either an immediate value in the command or the parameter memory) of the control parameter necessary for command execution, and outputs, in external parameter read entry information 233, entry information as a pointer that identifies the readout position in the parameter memory 250 when the parameter memory 250 is employed as the reference source of the control parameter. When the parameter memory 250 is not referenced as the control parameter, the command memory 230 outputs the immediate value of the control parameter as the external parameter read entry information 233.

The decoding section 240 interprets the computation information 231 relating to the command in execution and outputs the decoding result information 241 to the quantum device control signal generating section 320 and the sequence control section 220.

The parameter memory 250 has a memory structure formed from a plurality of entries that can each be identified by the entry number, and stores one parameter by one entry or two or more consecutive entries. When reference to the parameter memory is made from the command memory 230 through the external parameter read entry information 233, the parameter memory 250 reads out a parameter value in the entry specified by the entry number or a plurality of entries consecutive from the entry specified by the entry number, and outputs the parameter value as parameter memory output data 251.

In general, the range (bit width) of the parameter necessary for command execution is defined regarding each piece of the computation information of the relevant command. Therefore, parameters with different bit widths can be stored in the parameter memory 250 in a mixed manner. Although not particularly limited, the bit width of the control parameter that can be stored in each entry of the parameter memory 250 may be implemented according to the parameter with the largest bit width in all parameters included in all commands supported by the control device 200 (that is, all control parameters referenced from each command) (for example, implemented as the maximum bit width or larger). Alternatively, the bit width may be allowed to be extended through reading out the contents of a plurality of entries consecutive simultaneously or repeatedly and then coupling the contents. That is, a plurality of entries adjacent in the parameter memory 250 may be simultaneously referenced when the bit width of the control parameter that can be stored in each entry of the parameter memory 250 is smaller than the maximum bit width in all control parameters referenced from each command supported by the control device 200. In the former case, the bit efficiency of the memory can be increased by ensuring the performance through one time of readout. In the latter case, the use efficiency of the memory can be increased by suppressing the bit width. In the latter case, the control parameter value corresponding to the maximum bit width may always be read out and output in the parameter memory output data 251, and only the control parameter value corresponding to the valid bit width may be cut out and referenced on the side that refers to the control parameter, that is, at the quantum device control signal generating section 320.

Furthermore, the number of parameters necessary for command execution is also defined regarding each piece of the computation information of the relevant command. Therefore, the number of times of reference to the parameter memory 250 can vary for each command. Although not particularly limited, the number of simultaneous references to the parameter memory 250 may be made to correspond with the maximum number in the numbers of control parameters of all commands supported by the control device 200 to minimize the time required for the reference. Alternatively, by executing repetition while shifting the time for a plurality of times of reference, the number of simultaneous references may be set to one, which is the minimum number, to reduce the hardware scale. In the former, for example, the number of simultaneous references may be equal to or larger than the maximum number of the number of control parameters that each command supported by the control device 200 has. Furthermore, in the latter, for example, reference operation may be processed in a time-sharing manner when the number of references that can be simultaneously processed by the parameter memory 250 is smaller than the maximum number of the number of control parameters that each command supported by the control device 200 has.

At least part of the entries of the parameter memory 250 may be configured as a read-only area. An error in the set value can be alleviated in the case of executing a special command regarding which the control parameter value is definitive, such as the case of initializing quantum bits or the case of setting the quantum computation section 420 to a special control state for control parameter calibration. Besides, the hardware scale of the parameter memory 250 can be reduced through reduction in transistors.

The control interface 213 is used also when the contents of the entry of the parameter memory 250 updated by the calibration control section 340 are transferred to the side of the host PC 100.

An immediate value/parameter selecting section 310 selects either the immediate value, i.e. the external parameter read entry information 233 itself, or the reference, i.e. the parameter memory output data 251, as the control parameter relating to the command in execution on the basis of the external parameter selection signal 232, and outputs the selected parameter to the quantum device control signal generating section 320 as a computation parameter 311.

To avoid complexity of the drawing, only one element is illustrated as each of the immediate value/parameter selecting section 310 and the computation parameter 311. However, the same number of elements as the number of simultaneous references to the parameter memory 250 described above may be disposed regarding both. When references to a plurality of parameters are executed in a time-sharing manner, a latch circuit may be added to the side of the quantum device control signal generating section 320 in order to absorb the difference in the arrival time between the parameters.

The quantum device control signal generating section 320 outputs the following kinds of information and signals in accordance with the decoding result information 241 and the computation parameter 311 in the period during which the quantum device control signal generating section 320 is notified that the sequence control section 220 is in the command executing state by the command executing state signal 221. Specifically, the quantum device control signal generating section 320 generates and outputs each of a quantum device control signal 321 including primitive control information aimed at quantum bits included in the quantum computation section 420 and a strobe signal indicating the switching timing of the control information, a computation result readout control signal 322 to control selection and acquisition of computation result readout data in the computation result readout section 330, and a computation result accumulation control signal 323 to control arrival of the computation result readout data to the calibration control section 340 and accumulation of this data.

Although not particularly limited, the quantum device control signal generating section 320 includes a bias voltage generating section composed of voltage sources of a plurality of channels that independently operate, a bias voltage switching control section that controls selection of an applied bias voltage to bias voltage control lines disposed for each quantum bit in the quantum computation section 420 and controls switching of the selection state, a computation high-frequency generating section that generates a high-frequency signal to control spin rotation of a single electron confined in the quantum bit, and a timing control section necessary for time control among various kinds of processing.

The quantum device 400 includes a quantum computation control section 410 and the quantum computation section 420.

The quantum computation control section 410 temporarily accumulates at least part of the control information input from the quantum device control signal generating section 320 through the quantum device control signal 321. In addition to this temporary accumulation, the quantum computation control section 410 switches the application state of a quantum computation section control signal 411 including the bias voltage control line and the computation high-frequency signal, that becomes a direct control signal for each quantum bit of the quantum computation section 420, on the basis of the strobe signal included in the quantum device control signal 321, and outputs it to the quantum computation section 420.

The quantum computation section 420 is a quantum bit array in which a plurality of quantum bits whose characteristics can be varied by the applied bias voltage are connected into a one-dimensional or two-dimensional shape through a transfer gate that controls the degree of electron migration and interaction between the quantum bits by the bias voltage similarly. The quantum computation section 420 executes quantum operation based on the application state of the quantum computation section control signal 411 and outputs quantum computation section output signals 421 including a quantum computation result. Here, the quantum computation result is obtained by observing the spin state of a single electron confined in the quantum bit, and converting the spin state to a binary value to discriminate 0 or 1 in the classical computer.

Although not particularly limited, the quantum computation section output signals 421 may include part of the quantum computation section control signal 411 for the purpose of acquiring data necessary for calibration processing of the control parameter. For example, the quantum computation section output signals 421, which are output signals from the quantum bit array, may include part of signals to control the quantum bit array. This can implement an effective calibration function. Furthermore, each of the quantum computation section output signals 421 may be already converted to binary values or may be an analog value on the premise of A/D conversion processing in the computation result readout section 330.

The computation result readout section 330 selects one from signals included in the quantum computation section output signals 421 on the basis of the computation result readout control signal 322. For example, the computation result readout section 330 may be configured to selectively acquire the contents of one of the quantum computation section output signals 421, which are output signals from the quantum bit array, and support the acquired signal as a calibration support command. This can execute calibration processing as part of the sequence. When the selected signal is an analog output, the computation result readout section 330 executes analog-to-digital conversion and then outputs latched digital data as computation result readout data 331.

The calibration control section 340 saves the contents of the computation result readout data 331 in an internal predetermined area on the basis of the computation result accumulation control signal 323, and executes calibration computation defined by a calibration condition set through the control interface 217 in advance. When having completed the calibration computation relating to a specified number of computation results, the calibration control section 340 executes calibration of the set value of the control parameter specified as the calibration target in accordance with a predetermined calculation condition, such as reducing the difference between the calibration computation result and a target value, and outputs a parameter memory update control signal 341 to write the calibrated control parameter to the entry in the parameter memory 250 in which this control parameter is stored.

The host PC 100 can refer to the quantum computation result accumulated in the calibration control section 340 via the host interface 101, the host interface section 210, and the control interface 217.

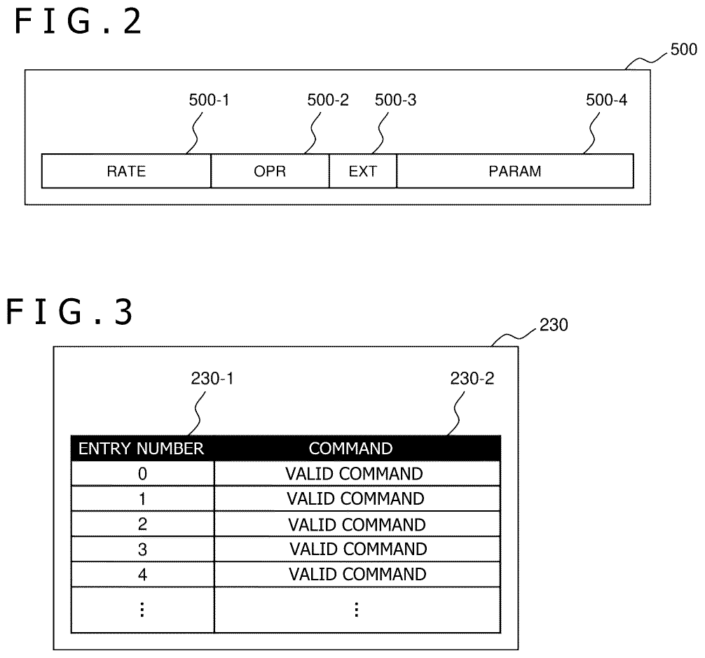

FIG. 2 illustrates one example of a command format 500 supported by the control device 200. Each one command is stored per one entry of the command memory 230 and is composed of the following fields.

Rate information specifying field (500-1, RATE): it is a field to specify the rate information equivalent to the execution time of the relevant command, and the contents of this field are output in the command memory control signal 222 when an instruction to start command execution is received from the sequence control section 220.

Operation information specifying field (500-2, OPR): it is a field to specify the contents of operation of the relevant command, and the contents of this field are output in the computation information 231 when an instruction to start command execution is received from the sequence control section 220. Although there is no particular limit, as one example of the contents of operation, there is operation relating to the respective functions corresponding to the primitive control signal generated by the quantum device control signal generating section 320, that is, voltage setting of the bias voltage generating section composed of the voltage sources of the plurality of channels that independently operate, setting of the selection control information of the applied bias voltage to each bias voltage control line, setting of the waveform envelope of the computation high-frequency signal, switching of the application state of the bias voltage, output gating of the computation high-frequency signal, and generation of various strobe signals to make an instruction of the timing of readout or accumulation of a computation result. In addition, as one example of the contents of operation to support sequence control or calibration processing, operation relating to the following kinds of operation may exist: notification indicating that the relevant command is the last command of the quantum computation sequence (command sequence), initialization operation for the quantum bit or at least part of control signals to the quantum bit, and operation of selectively connecting the specific bias voltage control line to the quantum computation section output signals 421 and drawing it out to the external of the quantum device 400 for the purpose of observing the internal of the quantum bit array as part of the calibration processing.

External parameter selection field (500-3, EXT): it is a field to select whether to specify the control parameter necessary for execution of the relevant command by an immediate value in the command or specify the control parameter through reference to the parameter memory 250, and the contents of this field are output in the external parameter selection signal 232 when an instruction to start command execution is received from the sequence control section 220.

Parameter specifying field (500-4, PARAM): it is a field to specify either the immediate value of the control parameter necessary for execution of the relevant command or reference (entry number) to the control parameter stored in the parameter memory 250, and the contents of this field are output in the external parameter read entry information 233 when an instruction to start command execution from the sequence control section 220 is received. Which of the immediate value and the reference this field is set to is distinguished according to the contents of the external parameter selection field 500-3.

In the present embodiment, the number of control parameters is one for simplification of explanation. However, the number of control parameters may be two or more. In this case, the command format may be extended to allow setting of the same number of external parameter selection fields 500-3 and parameter specifying fields 500-4 as the maximum number in the numbers of control parameters of all commands supported by the control device 200. Furthermore, part of the control parameters may be allowed to be set with only the immediate value and the external parameter selection field relating to these control parameters may be deleted.

Several selection options are assumed regarding which of the immediate value and the reference is set in the parameter specifying field 500-4. The feature of the immediate value is that the value is settled at the timing of creation of the quantum computation sequence in a step equivalent to compiling in the classical computer, and therefore the possibility that the value is accidentally updated after being created is low. The feature of the reference is that the value can be updated or calibrated independently of the sequence even after creation of the quantum computation sequence. Typically, in view of the memory use efficiency, it is preferable to set the immediate value if the bit width of the control parameter is equal to or smaller than the bit width of the parameter specifying field 500-4 or, if not, set the reference. That is, when the bit width of the control parameter referenced by the command is equal to or smaller than the bit width defined in the command format of the command or when the frequency of calibration demanded for this control parameter is low to a certain extent or in the case of deterring calibration of this control parameter, the immediate value may be employed as this parameter. If not, the reference destination in the parameter memory regarding this control parameter may be set in the command. However, there is also a choice of, while taking advantage of the above-described features, employing the reference for the control parameter for which calibration at a high frequency is demanded in one round of a temperature cycle and employing the immediate value for the control parameter accompanying a specific command relating to initialization of the quantum bits or calibration of the control parameter.

Although not particularly limited, the immediate value specified in the parameter specifying field 500-4 may be converted to a control parameter value different from the immediate value before command execution in the respective functional blocks in the quantum device control signal generating section 320 that is the command execution entity. When the control parameter value of the command is definitive, that is, when it is sure to a certain extent that the control parameter of this command is any of a small number of candidate values in terms of design of the hardware, selecting one of the candidate values is allowed by using the immediate value. That is, labor of specifying the control parameter can be greatly simplified and the memory capacity can be reduced by providing means that selects any of a small number of candidate values on the basis of the immediate value set in the command before execution of this command when it is sure to a certain extent that the control parameter referenced by this command is any of the candidate values.

FIG. 3 illustrates one example of the contents of the command memory 230. This command memory is composed of a plurality of command specifying fields 230-2 that can each be identified by an entry number 230-1, and one command having the command format 500 is stored in each command specifying field. Although not particularly limited, the quantum computation sequence (command sequence) starts to be executed from the entry specified as the execution start entry in the sequence control section 220 and is sequentially executed in ascending order of the entry number to end when the command indicating the termination of the quantum computation sequence has been executed.

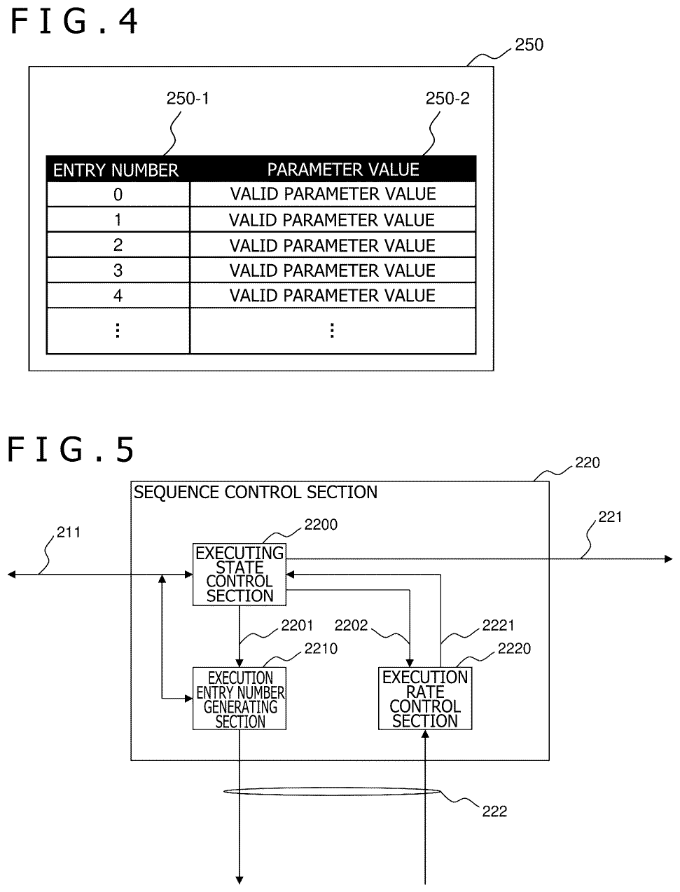

FIG. 4 illustrates one example of the contents of the parameter memory 250. This parameter memory is composed of a plurality of parameter value specifying fields 250-2 that can each be identified by an entry number 250-1, and the set value of the control parameter referenced from each command in the command memory 230 is stored in each parameter value specifying field. When the bit width of the control parameter is larger than the bit width of the parameter value specifying field 250-2, this control parameter may be stored in such a manner that a plurality of entries in which entries specified by the entry number are consecutive in ascending order and regarding which the number of entries is fixed are treated as one entry logically coupled from the lower-order bit toward the higher-order bit. It should be noted that whether or not the function of implementing the coupling of a plurality of entries like the above-described one is settled at the timing of design of the command specification of the control device 200.

FIG. 5 illustrates one example of the detailed configuration of the sequence control section 220. The sequence control section 220 includes an executing state control section 2200, an execution entry number generating section 2210, and an execution rate control section 2220.

The executing state control section 2200 makes a transition of the state of the sequence control section 220 to the command executing state when receiving an execution request of the quantum computation sequence (command sequence) from the host PC 100 through the control interface 211.

The executing state control section 2200 in the command executing state instructs the execution entry number generating section 2210 to start execution of new one command through an execution start request signal 2201 and simultaneously instructs the execution rate control section 2220 to execute initialization of the internal state for execution time management that is preparation work for the command execution start through an execution start request signal 2202. Then, the executing state control section 2200 waits until receiving a notification of execution completion of this command.

When execution completion of the command and information indicating whether or not this command is the termination (termination command) of the command sequence are notified from the execution rate control section 2220 by an execution completion notification signal 2221, if this command is not the termination command, the executing state control section 2200 in the command executing state instructs each of the execution entry number generating section 2210 and the execution rate control section 2220 to start execution of new one entry. If the command is the termination command, the executing state control section 2200 determines that execution of the whole of the quantum computation sequence (command sequence) regarding which the instruction of execution has been made from the host PC 100 has been completed, and makes a transition of the state of the sequence control section 220 to the command non-executing state.

Furthermore, the executing state control section 2200 always output the command executing state signal 221 indicating whether or not the sequence control section 220 is in the command executing state to the quantum device control signal generating section 320.

The execution entry number generating section 2210 holds the entry number (command read pointer) indicating the storing position in the command memory 230 regarding the command that should be executed when a new command execution start request is received from the execution start request signal 2201.

The execution entry number generating section 2210 that has received the new command execution start request by the execution start request signal 2201 outputs the command read pointer in the command memory control signal 222 as the readout target entry and increments the value of the pointer.

Although not particularly limited, the command read pointer may be allowed to be set by the user from the host PC 100 through the control interface 211 such that execution of the command sequence can be started from an optional entry in the command memory 230.

The execution rate control section 2220 manages the command execution time, that is, the elapsed time from the command execution start request, on the basis of the rate information specified as part of the command.

The execution rate control section 2220 that has received the new command execution start request by the execution start request signal 2202 initializes the internal state for execution time management (typically counter that executes counting in units of the system clock) on the basis of the rate information on the relevant command acquired from the command memory control signal 222 and immediately measures the elapsed time from the execution start. For example, the rate information is expressed by a multiple of a reference time that can be treated by the control device 200, such as the system clock.

In addition, the execution rate control section 2220 acquires information indicating whether or not the command that has started to be executed is the termination (termination command) of the command sequence as part of the decoding result information 241.

The execution rate control section 2220 that has detected the elapse of the execution time specified by the rate information notifies the executing state control section 2200 of execution completion of the command and information indicating whether or not this command is the termination command through the execution completion notification signal 2221.

FIG. 6 illustrates one example of the detailed configuration of the calibration control section 340. The calibration control section 340 includes a calibration target setting section 3400, a computation result accumulating section 3410, a calibration computation executing section 3420, and a post-calibration parameter calculating section 3430.

The calibration target setting section 3400 holds various kinds of control information that are set from the host PC 100 via the control interface 217 and define a detailed calibration operation condition. The calibration target setting section 3400 outputs, in a calibration computation control signal 3401, information to identify the algorithm of calibration computation and a calibration computation condition such as the number of computation target data and outputs, in a calibration target control signal 3402, information to identify the target value of calibration computation output and the procedure of calculation of the post-calibration control parameter and information to identify the entry number in the parameter memory 250 in which the control parameter that becomes a calibration target is stored.

Furthermore, when a request for reference to the quantum computation result is made from the control interface 217, the calibration target setting section 3400 notifies the computation result accumulating section 3410 in which the quantum computation result is accumulated of this request through a computation result readout control signal 3404. Moreover, the calibration target setting section 3400 outputs, as a response, the quantum computation result read out from the computation result accumulating section 3410 to the control interface 217.

The computation result accumulating section 3410 stores the computation result readout data 331 in a predetermined storage area incorporated therein at a timing specified by the computation result accumulation control signal 323, and outputs this data, that is, the one data stored last, to the calibration computation executing section 3420 as accumulated data 3411.

The calibration computation executing section 3420 operates on the basis of the timing specified by the computation result accumulation control signal 323 and executes calibration computation for the accumulated data 341 in accordance with the calibration computation control signal 3401. The calibration computation result is cumulatively stored in every calibration computation. When the calibration computation for the number of computation target data specified as part of the calibration computation control signal 3401 has been completed, the calibration computation executing section 3420 outputs the calibration computation result as calibration computation result information 3421.

The post-calibration parameter calculating section 3430 calculates the post-calibration control parameter from the calibration computation result information 3421 on the basis of the calibration target control signal 3402 and outputs the post-calibration control parameter as the parameter memory update control signal 341 together with the writing destination entry number of the parameter memory 250.

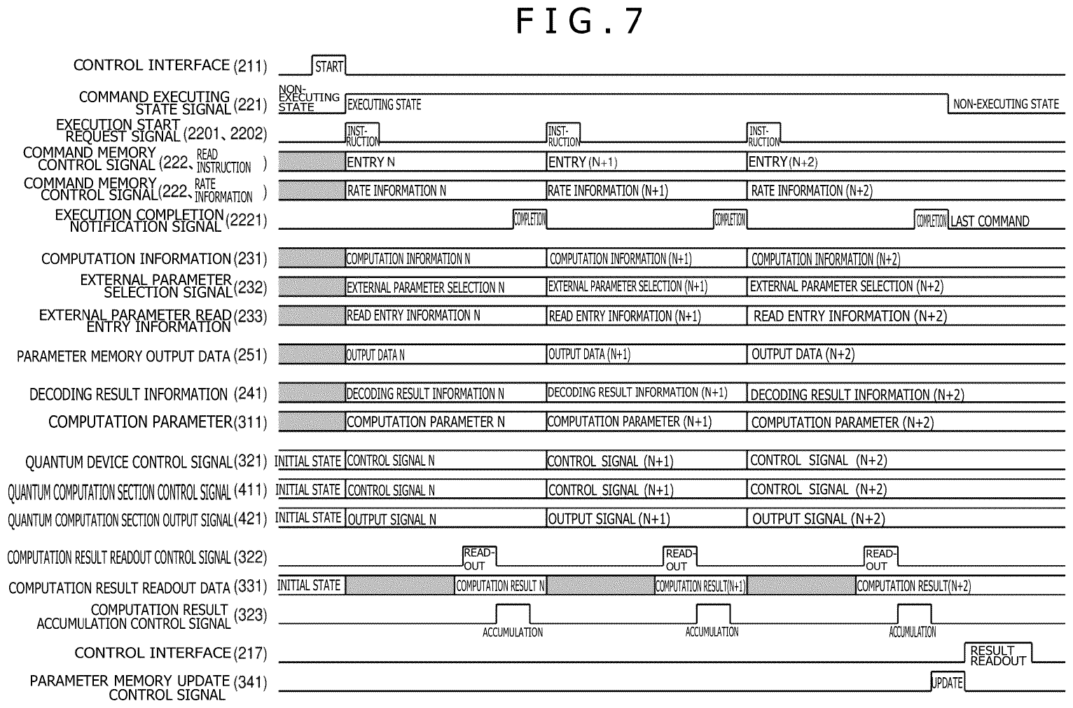

FIG. 7 is a timing chart illustrating one example of quantum computation sequence processing by the system control application that operates on the host PC 100 in the quantum computation system 1 according to the first embodiment. This timing chart is a timing chart that illustrates the one example of the quantum computation sequence processing and comprehensively illustrates the overall control including command execution control in the control device 200 and quantum operation in the quantum device 400, starting from an execution request of the quantum computation sequence (command sequence). Here, suppose that the command sequence is stored in such a manner that one command is stored in each of consecutive three entries from an entry N to an entry (N+2) in the command memory 230. Furthermore, suppose that a value N is set in the command read pointer indicating the execution start entry number of the command memory 230 in the execution entry number generating section 2210 and the initial state of the sequence control section 220 is the command non-executing state.

When the host PC 100 requests execution of the quantum computation sequence (command sequence) via the control interface 211, the executing state control section 2200 makes a transition of the state of the sequence control section 220 to the command executing state and requests execution start of the sequence first command through the execution start request signals 2201 and 2202.

The execution entry number generating section 2210 that has received the execution start request signal 2201 outputs the value N of the command read pointer as the readout entry number of the command memory 230 for the command memory control signal 222. Moreover, the execution rate control section 2220 that has received the execution start request signal 2202 acquires, from the command memory control signal 222, the contents of the rate information specifying field 500-1 of the sequence first command stored in the entry N of the command memory 230 and starts measurement of the execution time of the relevant command.

The command memory 230 that has received the command execution request from the command memory control signal 222 outputs the following information in addition to the above-described rate information. Specifically, the command memory 230 outputs, as the computation information 231, the contents of the operation information specifying field 500-2 in the sequence first command stored in the entry N. Furthermore, the command memory 230 outputs the contents of the external parameter selection field 500-3 as the external parameter selection signal 232 and outputs the contents of the parameter specifying field 500-4 as the external parameter read entry information 233.

When reference to the parameter memory 250 is executed on the basis of the external parameter read entry information 233, the parameter memory 250 reads out the parameter value specifying field 250-2 of one entry specified by the entry number or a predetermined plurality of entries consecutive in ascending order of the number from the entry specified by the entry number. In the case of the plurality of entries, the parameter memory 250 sequentially couples the entries from the lower-order bit side to the higher-order bit side to cause the entries to become one data, and outputs the parameter value of these entries as one piece of the parameter memory output data 251.

The decoding section 240 decodes the computation information 231 relating to the sequence first command output from the command memory 230 and outputs the decoding result as the decoding result information 241.

The immediate value/parameter selecting section 310 selects either the immediate value, i.e. the external parameter read entry information 233, or the reference, i.e. the parameter memory output data 251, as the control parameter at the time of command execution on the basis of the external parameter selection signal 232 in the sequence first command output from the command memory 230, and outputs the control parameter as the computation parameter 311.

The quantum device control signal generating section 320 executes operation specified by the decoding result information 241 by using the control parameter indicated by the computation parameter 311 regarding the sequence first command output from the command memory 230, and generates and outputs the quantum device control signal 321, the computation result readout control signal 322, and the computation result accumulation control signal 323.

The quantum computation control section 410 generates the quantum computation section control signal 411 to directly control the quantum bits included in the quantum computation section 420 on the basis of the quantum device control signal 321 generated regarding the sequence first command. The quantum computation section 420 executes quantum operation specified by the quantum computation section control signal 411 and outputs the quantum computation section output signals 421 including part of the quantum computation section control signal 411 as the data necessary for calibration processing of the control parameter.

The computation result readout section 330 selects one signal from signals included in the quantum computation section output signals 421 on the basis of the computation result readout control signal 322 relating to the sequence first command. When this signal is an analog output, the computation result readout section 330 executes analog-to-digital conversion and outputs a digital value as the computation result readout data 331.

The calibration control section 340 internally accumulates the computation result readout data 331 on the basis of the computation result accumulation control signal 323 relating to the sequence first command, and executes specified calibration computation for the accumulated data.

The execution rate control section 2220 that has been measuring the elapsed time from the command execution start notifies, when detecting the elapse of the command execution time specified by the rate information, the executing state control section 2200 about that, through the execution completion notification signal 2221, together with information indicating that the relevant command is not the termination of the command sequence. The executing state control section 2200 that has received the execution completion notification confirms that the relevant command is not the termination of the command sequence, and requests execution of the subsequent command stored in the entry (N+1) of the command memory 230 by the execution start request signals 2201 and 2202.

From then on, the control device 200 sequentially executes the above-described series of processing one by one until the termination command of the quantum computation sequence (command sequence).

The execution rate control section 2220 that has detected the elapse of the command execution time specified by the rate information regarding the termination command of the quantum computation sequence (command sequence) stored in the entry (N+2) of the command memory 230 notifies the executing state control section 2200 about that, through the execution completion notification signal 2221, together with information indicating that the relevant command is the termination of the command sequence. The executing state control section 2200 that has received the execution completion notification confirms that the relevant command is the termination of the command sequence, and makes a transition of the state of the sequence control section 220 to the command non-executing state.

Furthermore, when calibration computation for the number of computation target data specified in advance has been completed, the calibration control section 340 calculates the post-calibration control parameter from the calibration computation result information 3421, and requests update for the entry in which the calibration target control parameter is stored in the parameter memory 250 by the parameter memory update control signal 341.

The host PC 100 that has been monitoring the state of the sequence control section 220 acquires the quantum computation result accumulated in the computation result accumulating section 3410 through the control interface 217 when confirming that this state is the command non-executing state, that is, that the execution of the quantum computation sequence (command sequence) regarding which the instruction of the execution has been made been completed.

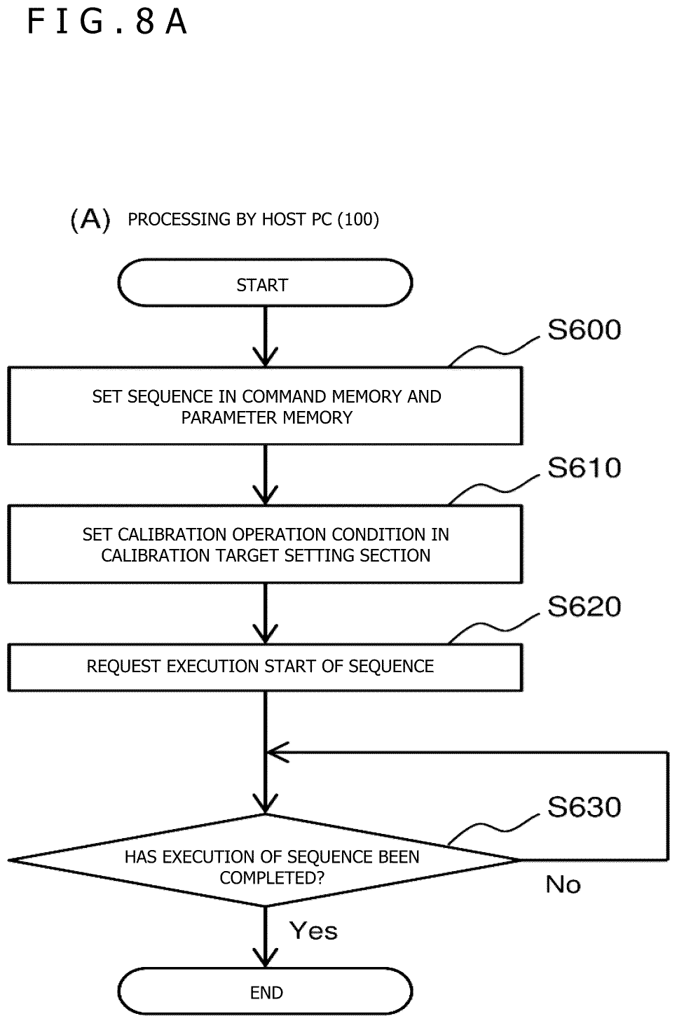

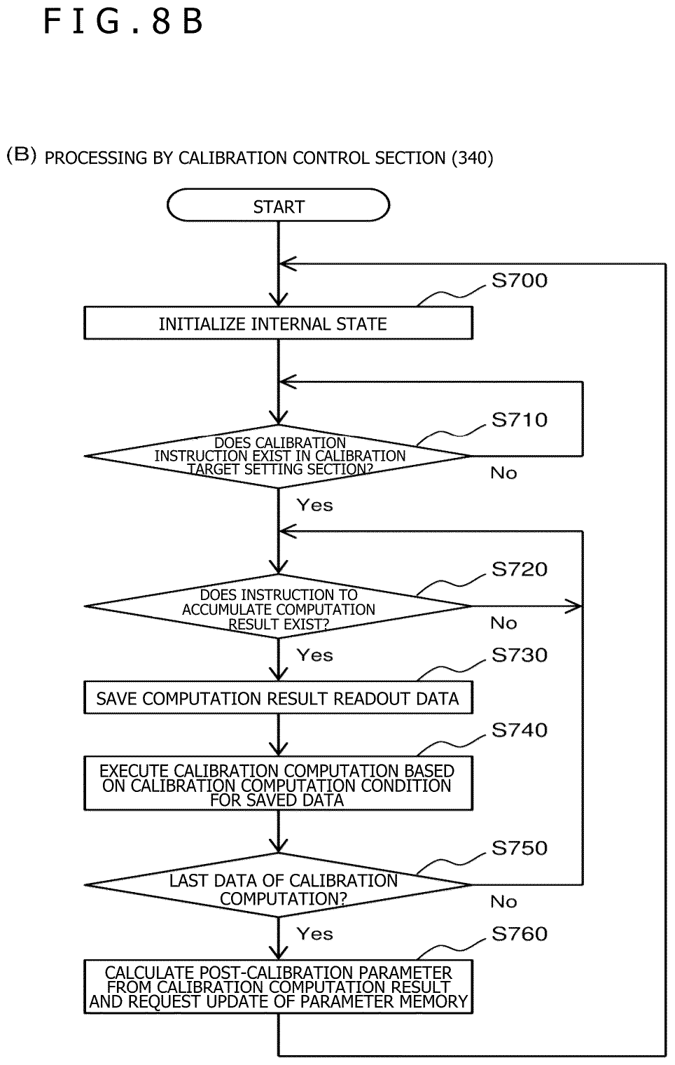

FIGS. 8A and 8B are flowcharts illustrating a series of procedure relating to calibration processing of the control parameter in the quantum computation system 1 according to the first embodiment. The calibration processing is divided into processing by the host PC 100 (A) (FIG. 8A) and processing by the calibration control section 340 (B) (FIG. 8B).

On the side of the host PC 100, first, in a step S600, a quantum computation sequence (command sequence) including commands to support sequence control and calibration processing are set in the command memory 230, and all control parameters referenced from the command memory 230 are set in the parameter memory 250.

Subsequently, in a step S610, the host PC 100 sets various kinds of control information that define a detailed calibration operation condition of the calibration control section 340 in the calibration target setting section 3400.

When the preparation necessary for execution of the quantum computation sequence (command sequence) has been completed, the host PC 100 requests the sequence control section 220 to execute the command sequence in a step S620.

The host PC 100 that has requested the execution of the quantum computation sequence (command sequence) monitors the state of the sequence control section 220 through the control interface 211 (step S630), and executes spin-waiting until the state returns to the command non-executing state due to execution completion of the whole of the command sequence (step S630, No).

When the execution of the whole of the command sequence has been completed and it is detected that the sequence control section 220 is in the command non-executing state (step S630, Yes), the processing on the side of the host PC 100 is completed and another kind of processing such as acquisition of the quantum computation result accumulated in the computation result accumulating section 3410 can be executed.

Meanwhile, on the side of the calibration control section 340, first, in a step S700, initialization of the internal state such as past calibration computation result information held in the calibration computation executing section 3420 is executed. The user may be allowed to select whether to simultaneously execute also clearing of quantum computation result data accumulated in the computation result accumulating section 3410 and initialization of the pointer indicating the writing position of the quantum computation result data.

Subsequently, the calibration control section 340 monitors whether or not a calibration computation instruction exists in a detailed calibration condition notified from the calibration target setting section 3400 to the calibration computation executing section 3420 (step S710). The calibration control section 340 executes spin-waiting when the calibration computation instruction does not exist (step S710, No), and starts the following calibration computation when the instruction exists (step S710, Yes).

First, the calibration control section 340 checks whether an instruction to accumulate computation result readout data exists by the computation result accumulation control signal 323 (step S720), and executes spin-waiting when the accumulation instruction does not exist (step S720, No). When the instruction exists (step S720, Yes), the calibration control section 340 saves the computation result readout data 331 in the computation result accumulating section 3410 (step S730) and executes, for this data, calibration computation based on the calibration computation condition set in advance (step S740).

The calibration control section 340 checks whether the calibration computation for the specified number of computation target data has been completed (step S750), and waits for a new instruction to accumulate the computation result readout data when the calibration computation has not been completed (step S750, No). When the calibration computation has been completed (step S750, Yes), the calibration control section 340 calculates the post-calibration control parameter on the basis of a set calculation condition regarding the control parameter that is the calibration target, and requests to update the calibration target control parameter in the parameter memory 250 to the post-calibration control parameter value through the parameter memory update control signal 341 (step S760).

According to the first embodiment described in detail above with use of drawings, the control parameter specifying referenced by the respective commands configuring the quantum computation sequence (command sequence) is separated into the parameter memory 250 from the command memory 230. Moreover, the control parameter calibration function provided by the calibration control section 340 that updates the contents of the parameter memory 250 is combined. For example, in the control device 200 that controls quantum operation in the quantum bit array in which a plurality of quantum bits are arranged one-dimensionally or two-dimensionally, the command memory 230 that stores a plurality of control commands and the parameter memory 250 that stores part or all of the control parameters accompanying the control commands are included, and the command format of the control command includes one or more parameter specifying fields to specify either the immediate value of the control parameter or the reference to the control parameter stored in the parameter memory. Furthermore, the control device 200 has the calibration control section 340 that calibrates the control parameter on the basis of the output signal (the calibration computation result information 3421) from the quantum bit array. Employing such a configuration can implement the quantum computation system 1 that can calibrate the control parameter value in such a manner as to follow temporal change in characteristics of the quantum bits that are the control target. Moreover, the sequence description can be diverted as it is even when change in the number of parameters or the size has occurred, and the correction range can be limited.

In addition, by defining the command to support the calibration function of the calibration control section 340 and including the command in the quantum computation sequence (command sequence), calibration of the control parameter can be autonomously executed concurrently with the primary quantum operation, and the practical utility of the quantum computation system 1 can be greatly improved.

### Second Embodiment

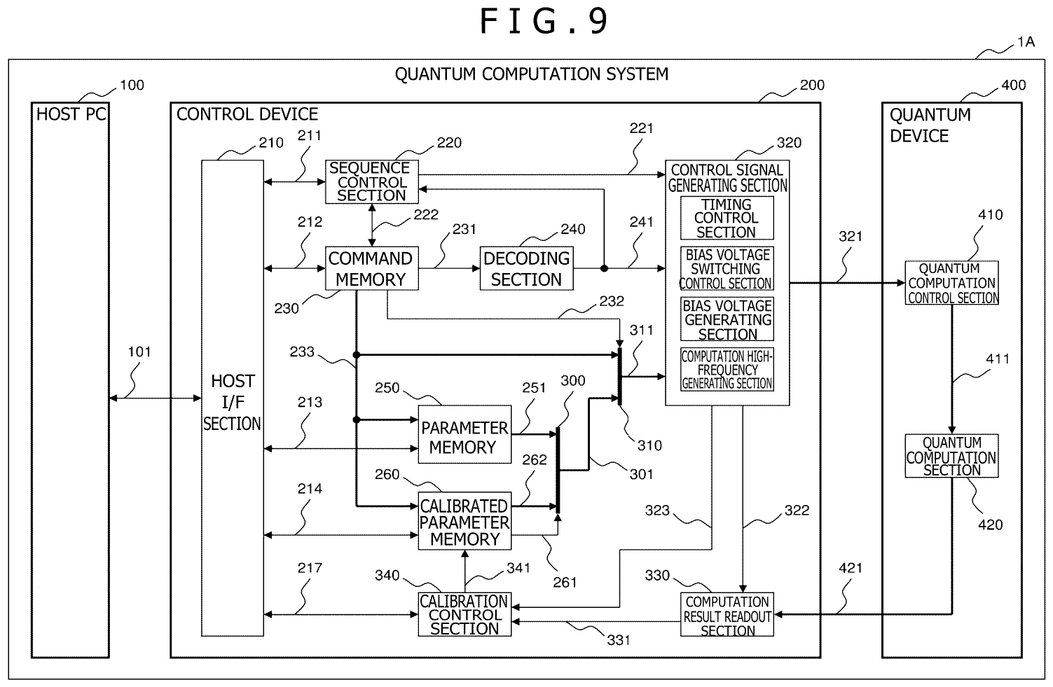

Subsequently, a quantum computation system 1A according to a second embodiment of the present invention will be described with reference to FIG. 9. The system configuration of the second embodiment is substantially the same as that in the first embodiment, and therefore overlapping description is omitted.

The configuration of the quantum computation system 1A compared with the configuration of the quantum computation system 1 is different in the following points. Specifically, a calibrated parameter memory 260 accessible from the host PC 100 through a control interface 214 is added and is connected in parallel to the parameter memory 250 to make the double parameter memory. In addition, added is a route on which either the parameter memory output data 251 that is the output of the parameter memory 250 or calibrated parameter memory output data 262 that is an output of the calibrated parameter memory 260 is selected in a calibrated parameter selecting section 300 on the basis of a parameter calibration-completion flag 261 that is another output of the calibrated parameter memory 260, and the control parameter value after the selection is output as an external parameter 301.

In association with the above-described constituent element addition, one of the inputs to the immediate value/parameter selecting section 310 is changed from the parameter memory output data 251 before making the double parameter memory to the external parameter 301. Furthermore, the connection destination of the parameter memory update control signal 341 is changed from the parameter memory 250 to the calibrated parameter memory 260.

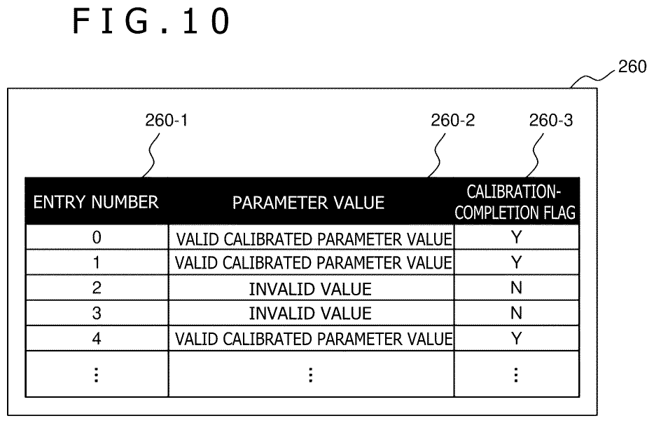

FIG. 10 illustrates one example of the contents of the calibrated parameter memory 260. This parameter memory is composed of a plurality of parameter value specifying fields 260-2 that can each be identified by an entry number 260-1 and parameter calibration-completion flag fields 260-3 indicating the validity of the calibrated parameter value stored in the parameter value specifying field 260-2 of the relevant entry. Although not particularly limited, the number of entries and the bit width of the parameter value specifying field in the calibrated parameter memory 260 are both common to those of the parameter memory 250.

In the initial state, the parameter calibration-completion flag fields 260-3 in the calibrated parameter memory 260 all indicate the invalid state. When receiving a request to write the calibrated control parameter from the parameter memory update control signal 341, the calibrated parameter memory 260 changes the contents of the parameter value specifying field 260-2 of the specified entry to the calibrated control parameter value, and changes the parameter calibration-completion flag field 260-3 to the valid state.

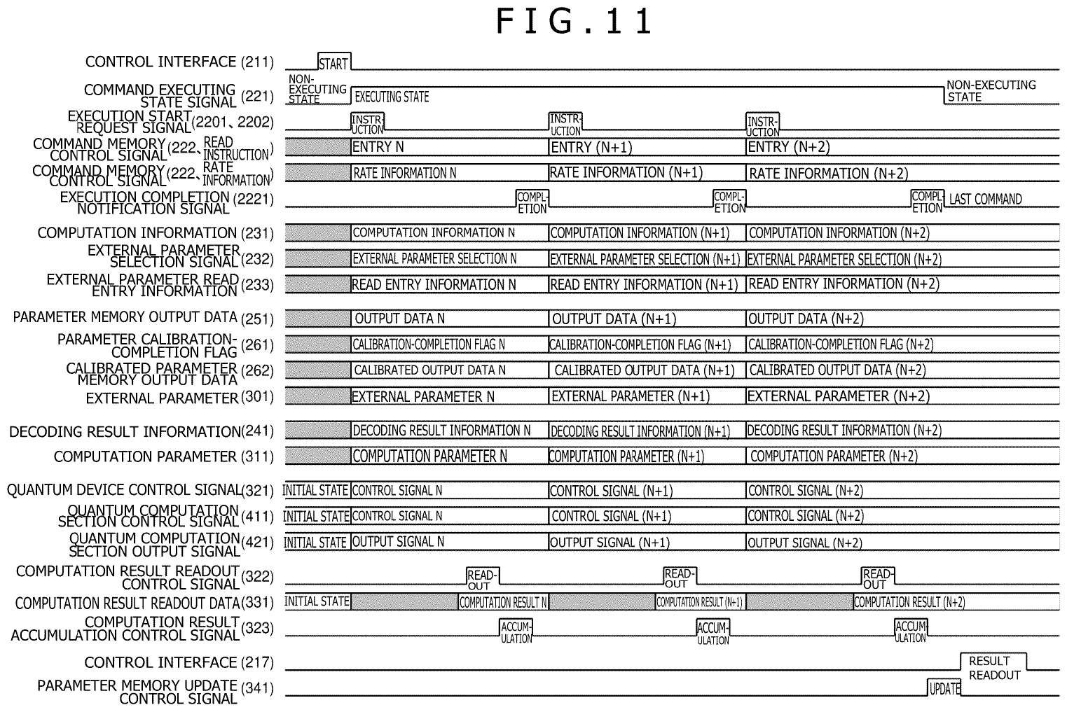

FIG. 11 is a timing chart illustrating one example of quantum computation sequence processing by the system control application that operates on the host PC 100 in the quantum computation system 1A according to the second embodiment. This timing chart is a timing chart that illustrates the one example of the quantum computation sequence processing and comprehensively illustrates the overall control including command execution control in the control device 200 and quantum operation in the quantum device 400, starting from an execution request of the quantum computation sequence (command sequence). This timing chart is substantially the same as that in the first embodiment illustrated in FIG. 7, and therefore description will be made only about a place relating to the difference in constituent elements of the quantum computation system.

Similarly to the first embodiment, the command memory 230 that has received a command execution request from the command memory control signal 222 outputs the contents of the parameter specifying field 500-4 as the external parameter read entry information 233.

When simultaneous reference to the parameter memory 250 and the calibrated parameter memory 260 is executed by the external parameter read entry information 233, the parameter memory 250 outputs, as the parameter memory output data 251, the control parameter value read out from one entry specified by the entry number or a predetermined plurality of entries consecutive in ascending order of the number from the entry specified by the entry number. Simultaneously, the calibrated parameter memory 260 outputs the control parameter value read out from the entry having the entry number equal to that in the parameter memory 250 as the calibrated parameter memory output data 262 and outputs, as the parameter calibration-completion flag 261, the parameter calibration-completion flag read out from the entry having the entry number equal to that in the parameter memory 250 (in the case of a plurality of entries, logical conjunction of all flags).

On the basis of the parameter calibration-completion flag 261, the calibrated parameter selecting section 300 selects the parameter memory output data 251 when the currently-referenced control parameter has not been calibrated (that is, invalid), and selects the calibrated parameter memory output data 262 when the currently-referenced control parameter has been calibrated (that is, valid), to output the selected data as the external parameter 301. That is, the constituent elements added in the second embodiment provide a function of selectively overriding the control parameter that has not been calibrated only when the specific control parameter has been calibrated.

Operation of the decoding section 240 is the same as that in the first embodiment, and the decoding section 240 decodes the computation information 231 and outputs the decoding result as the decoding result information 241.

The immediate value/parameter selecting section 310 selects either the immediate value, i.e. the external parameter read entry information 233, or the reference, i.e. the external parameter 301, which is the control parameter after the overriding replacing the parameter memory output data 251 before the overriding, on the basis of the external parameter selection signal 232 and outputs the selected value as the computation parameter 311.

Operation of the quantum device control signal generating section 320 to which the decoding result information 241 and the computation parameter 311 are input and the respective sections subsequent thereto is not different from that in the first embodiment except for whether or not the overriding of the control parameter exists.

In the second embodiment, although the hardware scale increases due to making the double parameter memory, highly safe and reliable control parameter update in which the influence on the quantum computation sequence in execution is suppressed is enabled by separating the storing destination of the control parameter into the parameter memories mutually different between before and after calibration.

Moreover, by adding means that forcibly sets only the state of the parameter calibration-completion flag 261 to the invalid state without changing the contents of the calibrated parameter memory 260, an operation scenario that calibration processing of the control parameter is executed whereas immediate application of the calibrated control parameter is deterred can be added. This scenario improves the flexibility in use of the control device 200, which is suitable for adjustment work of the calibration operation condition set by the calibration control section 340, for example.

### Third Embodiment

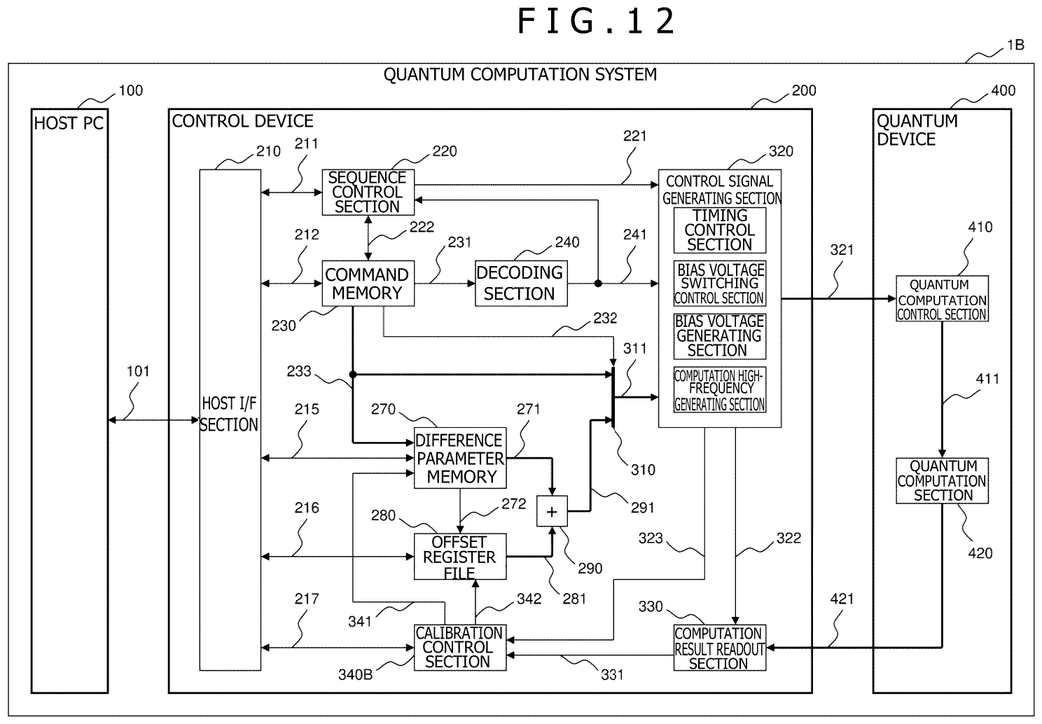

Subsequently, a quantum computation system 1B according to a third embodiment of the present invention will be described with reference to FIG. 12. The system configuration of the third embodiment is substantially the same as that in the first embodiment, and therefore overlapping description is omitted.

In the present embodiment, the configuration is changed in such a manner that the control parameter referenced by each command is not stored in the parameter memory 250 as it is but allowed to be calculated as the sum of an offset value set in an offset register and a difference value with respect to the offset value, set in a parameter memory.

The configuration of the quantum computation system 1B compared with the configuration of the quantum computation system 1 is different in the following points. Specifically, the parameter memory 250, and the control interface 213 and the parameter memory output data 251, which are the input and output thereof, are deleted. As substitutes for them, a difference parameter memory 270 that stores the above-described difference value, a control interface 215 that controls access to the difference parameter memory 270, an offset register file 280 that stores the above-described offset value, a control interface 216 that controls access to the offset register file 280, and an offset register number that is referenced when the control parameter is calculated from the difference value in the difference parameter memory 270 and identifies an offset register in the offset register file 280 are each added.

Moreover, an adder 290 that adds the contents of difference parameter memory output data 271 that is the output of the difference parameter memory 270 and the contents of offset register file output data 281 that is the output of the offset register file 280, and outputs the addition result as an external parameter 291 is also added. As above, in the present embodiment, the control parameter referenced by the command is calculated as the sum of the offset value set in the offset register and the parameter difference value with respect to the offset value, which is set in the difference parameter memory.

In conformity with the above-described constituent element addition, the calibration control section 340 is replaced by a calibration control section 340B. The calibration control section 340B changes the connection destination of the parameter memory update control signal 341 from the parameter memory 250 to the difference parameter memory 270. In addition, an offset register update control signal 342 that controls update of the offset register is added and is connected to the offset register file 280.

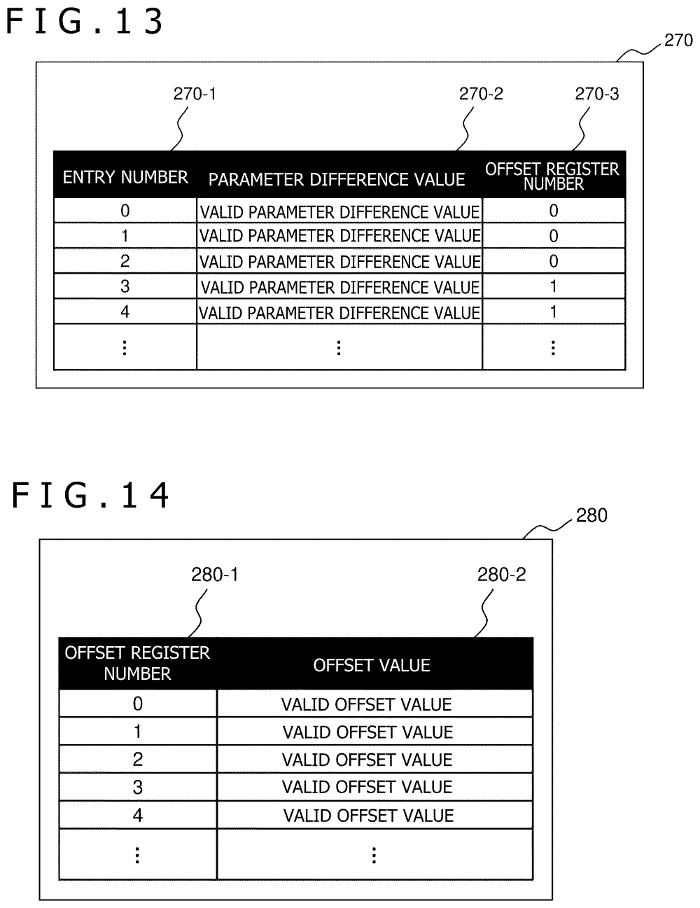

FIG. 13 illustrates one example of the contents of the difference parameter memory 270. This difference parameter memory is composed of a plurality of parameter difference value specifying fields 270-2 that can each be identified by an entry number 270-1 and offset register number specifying fields 270-3 to specify the offset register number referenced when the control parameter is calculated from the relevant parameter difference value. In each parameter difference value specifying field, only the difference value from the value set in the offset register specified as the reference destination is stored.

FIG. 14 illustrates one example of the contents of the offset register file 280. This offset register file is composed of a plurality of offset registers that can each be identified by an offset register number 280-1, that is, offset value specifying fields 280-2. In each offset value specifying field, only the offset value referenced when the control parameter value is calculated from the difference value in the difference parameter memory 270 is stored.

Although not particularly limited, the bit width of the offset value specifying field 280-2 may be implemented according to the parameter with the largest bit width in all parameters included in all commands supported by the control device 200. Furthermore, the parameter difference value specifying field 270-2 may be implemented to be smaller than the bit width of the parameter value specifying field 250-2. In addition, a configuration in which the number of offset registers is smaller than the number of entries of the difference parameter memory 270 is desirable. Due to the above-described configuration, particularly when a plurality of control parameters have distribution in which they concentrate in the vicinity of the specific offset value, the whole of the plurality of control parameters can be efficiently stored and treated with a small number of bits.

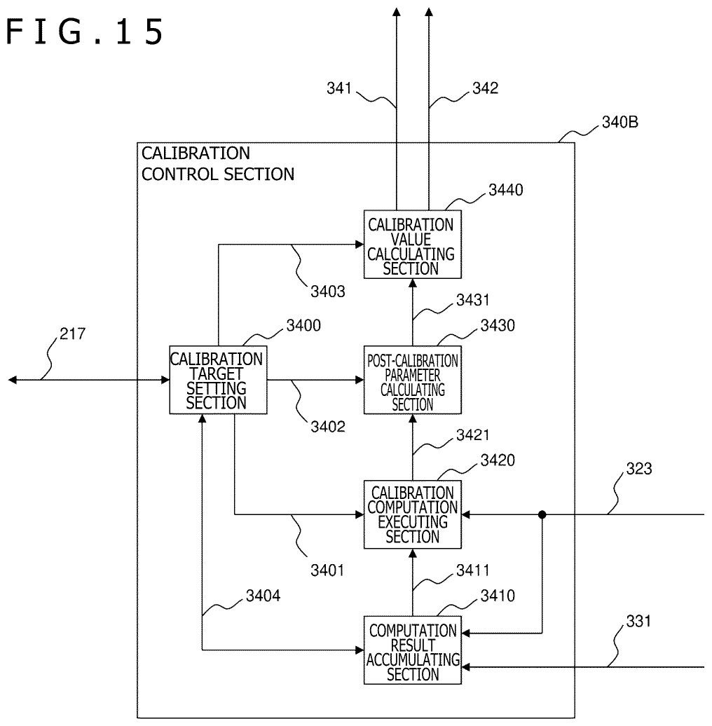

FIG. 15 illustrates one example of the detailed configuration of the calibration control section 340B. It is a modification of the calibration control section 340 described with use of FIG. 6, and functions of the constituent element having the same numeral are in common with each other unless otherwise noted, and overlapping description is omitted.

The calibration control section 340B includes a calibration value calculating section 3440 in addition to the calibration target setting section 3400, the computation result accumulating section 3410, the calibration computation executing section 3420, and the post-calibration parameter calculating section 3430.

The calibration target setting section 3400 holds various kinds of control information that are set from the host PC 100 via the control interface 217 and define a detailed calibration operation condition. The calibration target setting section 3400 outputs, in the calibration computation control signal 3401, information to identify the algorithm of calibration computation and a calibration computation condition such as the number of computation target data and outputs, in the calibration target control signal 3402, information to identify the target value of calibration computation output and the procedure of calculation of the post-calibration control parameter. In addition, the calibration target setting section 3400 outputs, in a calibration target selection signal 3403, the entry number in the difference parameter memory 270 in which the control parameter that becomes a calibration target is stored, the offset register number referenced from the relevant entry, and information to identify a calibration policy.

Although not particularly limited, the calibration policy includes the maximum variation width of the offset value permitted in one time of calibration, the selection priority of the calibration target (either the difference parameter value or the offset value), and assignment of the calibration amount (difference from the current value) regarding each calibration target.

Moreover, the calibration target setting section 3400 controls computation result readout through the computation result readout control signal 3404 with the computation result accumulating section 3410 similarly to the first embodiment. As above, the calibration target setting section 3400 sets the policy for executing calibration in such a manner that the difference in the control parameter value between before and after the calibration is divided into the calibration amount for the offset value and the calibration amount for the parameter difference value in calibration control of the control parameter.

Operations of the computation result accumulating section 3410 and the calibration computation executing section 3420 are both common to those in the first embodiment. They accumulate the computation result readout data 331, execute calibration computation relating to the relevant data, and output the calibration computation result as the calibration computation result information 3421 when the calibration computation for the specified number of computation target data has been completed.

The post-calibration parameter calculating section 3430 calculates a post-calibration control parameter 3431 from the calibration computation result information 3421 on the basis of the calibration target control signal 3402.

The calibration value calculating section 3440 calculates the calibration amount of each calibration target on the basis of the post-calibration control parameter 3431 and the calibration policy set by the calibration target selection signal 3403. The calibration value calculating section 3440 outputs the parameter memory update control signal 341 for writing, to the difference parameter memory 270, the post-calibration difference parameter value obtained by adding the calibration amount handled through change in the parameter value in the difference in the control parameter between before and after calibration (calibration amount) to the current difference parameter value. The calibration value calculating section 3440 outputs the offset register update control signal 342 for writing, to the offset register file 280, the post-calibration offset value obtained by adding the calibration amount handled through change in the offset value to the current offset value.

Here, the variable range of the difference parameter value with a relatively small bit width is restricted. On the other hand, the offset value having a sufficient bit width can be changed in the full scale. However, due to a characteristic that a plurality of control parameter values for which the relevant offset value is referenced are simultaneously affected, prudence is required for assignment of the calibration amount of each calibration target.

For example, the following calibration policy that gives priority to the difference parameter side is assumed. Specifically, the calibration amount that can be handled through correction of the difference parameter value in the calibration amount is all handled on the difference parameter side and only the remaining calibration amount is handled by the offset value. Thus, for example, employed is a configuration in which the bit width of the offset register is equal to or larger than the maximum bit width in all control parameters referenced from each command supported by the control device and the bit width of the parameter difference value stored in each entry of the difference parameter memory is smaller than the bit width of the control parameter stored in each entry of the parameter memory.

Conversely, the following calibration policy that gives priority to the offset side is assumed. Specifically, the maximum variation width of the offset value permitted in one time of calibration is defined and the calibration amount equal to or smaller than the maximum variation width is all handled on the offset side. Furthermore, only the remaining calibration amount is handled on the difference parameter side. Thus, for example, employed is a configuration in which the difference in the offset value between before and after calibration is limited to be equal to or smaller than the maximum variation width permitted in one time of calibration in calibration control of the control parameter. Moreover, in the latter calibration policy, possibly calibration becomes insufficient due to the restriction on the variable range of the difference parameter. Therefore, it is desirable for the calibration control section 340B to have such flexibility as to be capable of implementing a wide variety of calibration policies and further have means that checks whether or not calibration is successful.

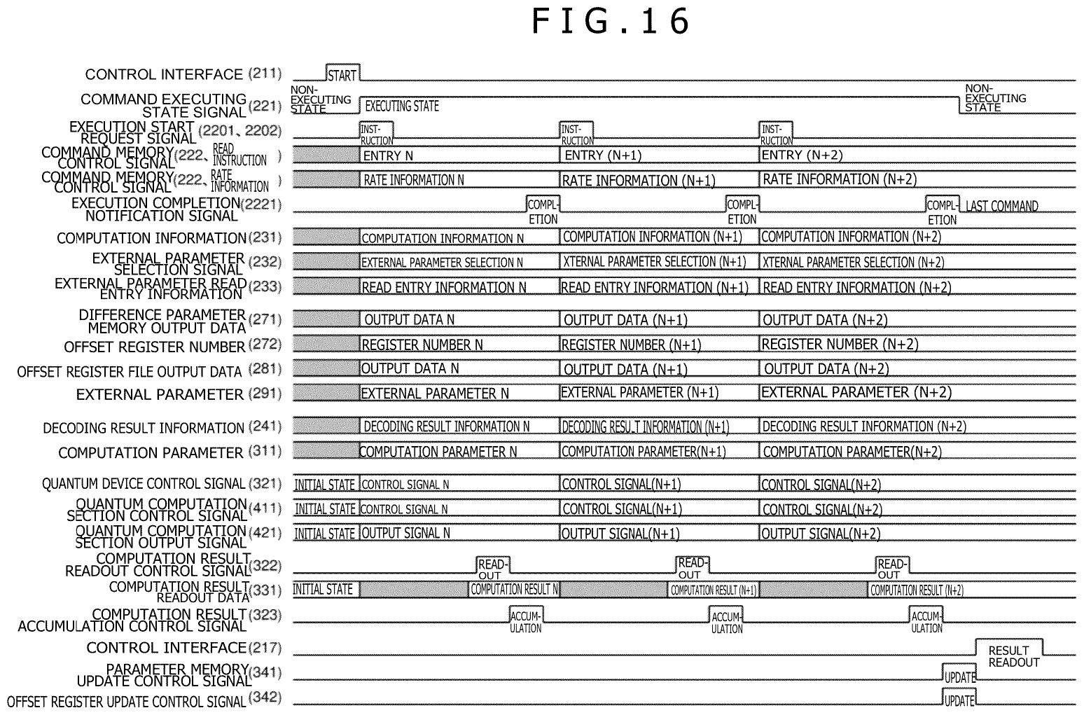

FIG. 16 is a timing chart illustrating one example of quantum computation sequence processing by the system control application that operates on the host PC 100 in the quantum computation system 1B according to the third embodiment. This timing chart is a timing chart that illustrates the one example of the quantum computation sequence processing and comprehensively illustrates the overall control including command execution control in the control device 200 and quantum operation in the quantum device 400, starting from an execution request of the quantum computation sequence (command sequence). This timing chart is substantially the same as that in the first embodiment illustrated in FIG. 7, and therefore description will be made only about a place relating to the difference in constituent elements of the quantum computation system.

Similarly to the first embodiment, the command memory 230 that has received a command execution request from the command memory control signal 222 outputs the contents of the parameter specifying field 500-4 as the external parameter read entry information 233.

When reference to the difference parameter memory 270 is executed by the external parameter read entry information 233, the difference parameter memory 270 outputs the parameter difference value read out from the entry specified by the entry number as the difference parameter memory output data 271 and outputs the offset register number of this entry as an offset register number 272.

The offset register file 280 that has received a reference request by the offset register number 272 outputs the contents of the offset register specified by the offset register number in the offset register file output data 281.

The adder 290 adds the contents of the difference parameter memory output data 271 and the contents of the offset register file output data 281 and outputs the addition result as the external parameter 291.

Operation of the decoding section 240 is the same as that in the first embodiment, and the decoding section 240 decodes the computation information 231 and outputs the decoding result as the decoding result information 241.

The immediate value/parameter selecting section 310 selects either the immediate value, i.e. the external parameter read entry information 233, or the reference, i.e. the external parameter 291 replacing the parameter memory output data 251, on the basis of the external parameter selection signal 232 and outputs the selected value as the computation parameter 311.

Operation of the quantum device control signal generating section 320 to which the decoding result information 241 and the computation parameter 311 are input and the respective sections subsequent thereto is not different from that in the first embodiment except that the signal relating to writing of the post-calibration control parameter is signals of two systems, which are the parameter memory update control signal 341 and the offset register update control signal 342, as already described in detail with reference to FIG. 15.

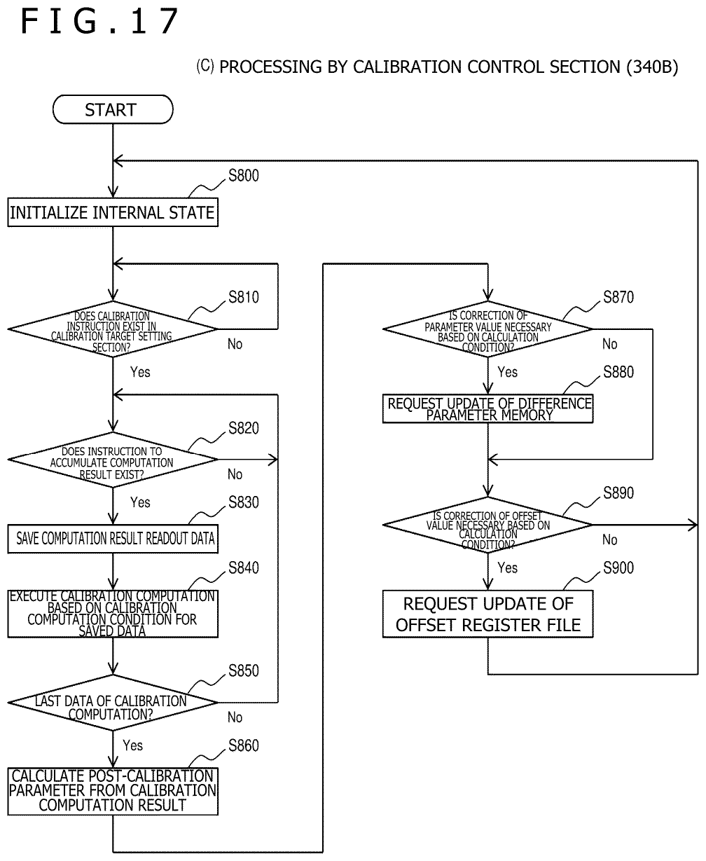

FIG. 17 is a flowchart illustrating a series of procedure relating to calibration processing of the control parameter in the quantum computation system 1B according to the third embodiment. The calibration processing is divided into processing by the host PC 100 (this processing is common to (A) in FIG. 8A and illustration and description thereof are omitted) and processing by the calibration control section 340B (C) (FIG. 17).

On the side of the calibration control section 340B, first, in a step S800, initialization of the internal state such as past calibration computation result information held in the calibration computation executing section 3420 is executed. The user may be allowed to select whether to simultaneously execute also clearing of quantum computation result data accumulated in the computation result accumulating section 3410 and initialization of the pointer indicating the writing position of the quantum computation result data.

Subsequently, the calibration control section 340B monitors whether or not a calibration computation instruction exists in a detailed calibration condition notified from the calibration target setting section 3400 to the calibration computation executing section 3420 (step S810). The calibration control section 340B executes spin-waiting when the calibration computation instruction does not exist (step S810, No), and starts the following calibration computation when the instruction exists (step S810, Yes).

First, the calibration control section 340B checks whether an instruction to accumulate computation result readout data exists by the computation result accumulation control signal 323 (step S820) and executes spin-waiting when the accumulation instruction does not exist (step S820, No). When the instruction exists (step S820, Yes), the calibration control section 340B saves the computation result readout data 331 in the computation result accumulating section 3410 (step S830) and executes, for this data, calibration computation based on the calibration computation condition set in advance (step S840).

The calibration control section 340B checks whether the calibration computation for the specified number of computation target data has been completed (step S850), and waits for a new instruction to accumulate the computation result readout data when the calibration computation has not been completed (step S850, No). When the calibration computation has been completed (step S850, Yes), the calibration control section 340B calibrates the control parameter specified as the calibration target on the basis of the set procedure of calculation of the post-calibration control parameter to calculate the post-calibration control parameter 3431 from the calibration computation result information 3421 (step S860).

Subsequently, the calibration control section 340B determines whether or not update of the difference parallel value is necessary on the basis of the difference in the control parameter between before and after the calibration (calibration amount) and the calibration policy (step S870). When update is necessary (step S870, Yes), the calibration control section 340B requests update of the difference parameter memory 270 through the parameter memory update control signal 341 (step S880). The calibration control section 340B skips this processing when update is unnecessary (step S870, No).

At last, the calibration control section 340B determines whether or not update of the offset value is necessary on the basis of the difference in the control parameter between before and after the calibration (calibration amount) and the calibration policy (step S890). When update is necessary (step S890, Yes), the calibration control section 340B requests update of the offset register file 280 through the offset register update control signal 342 (step S900). The calibration control section 340B skips this processing when update is unnecessary (step S890, No).

In the third embodiment, provided is means that efficiently stores and handles the whole of a plurality of control parameters with a small number of bits particularly when these control parameters have characteristic distribution, that is, these control parameters concentrate in the vicinity of one or a small number of specific values (offset values).

In addition, it becomes possible to collectively calibrate a plurality of control parameters for which a specific offset value is referenced, and an effect that the calibration processing in the control device 200 is made more efficient to improve the practical utility can be expected.

The embodiments of the present invention have been described above. However, these embodiments are suggested as examples and do not intend to limit the scope of the invention. It is possible for these novel embodiments to be carried out in other various forms and various kinds of omission, replacement, and change can be carried out without departing from the gist of the invention. These embodiments and modifications thereof are included in the scope and gist of the invention and are included in inventions set forth in the scope of claims and an equivalent scope thereof. Constituent elements described in the embodiments may be implemented by hardware designed for exclusive use, such as an application specific integrated circuit (ASIC), or may be implemented by programmable hardware such as a field-programmable gate array (FPGA). Furthermore, software that runs on the host PC may take charge of at least part of functions.

According to the above-described embodiments, it becomes possible to implement a practical quantum computer. Thus, the energy consumption is low and the carbon emission amount is reduced, which can contribute to prevention of global warming and realization of a sustainable society.

What is claimed is:

1. A control device that controls quantum operation in a quantum bit array in which a plurality of quantum bits are arranged one-dimensionally or two-dimensionally, the control device comprising:
a command memory that stores a plurality of control commands; and
a parameter memory that stores part or all of control parameters accompanying the control commands, wherein
a command format of the control commands includes one or more parameter specifying fields to specify either an immediate value of a control parameter or reference to the control parameter stored in the parameter memory.

2. The control device according to claim 1, further comprising:
a calibration control section that calibrates the control parameter on a basis of output signals from the quantum bit array.

3. The control device according to claim 1, wherein
a bit width of a control parameter allowed to be stored in each entry of the parameter memory is equal to or larger than a maximum bit width in all of the control parameters referenced from each command supported by the control device.

4. The control device according to claim 1, wherein
a plurality of adjacent entries in the parameter memory are simultaneously referenced when a bit width of a control parameter allowed to be stored in each entry of the parameter memory is smaller than a maximum bit width in all of the control parameters referenced from each command supported by the control device.

5. The control device according to claim 1, wherein
number of references allowed to be simultaneously processed by the parameter memory is equal to or larger than a maximum number of number of control parameters that each command supported by the control device has.

6. The control device according to claim 1, wherein
reference operation is processed in a time-sharing manner when number of references allowed to be simultaneously processed by the parameter memory is smaller than a maximum number of number of control parameters that each command supported by the control device has.

7. The control device according to claim 1,
at least part of the parameter memory is configured as a read-only area.

8. The control device according to claim 1, wherein
output signals from the quantum bit array include part of a signal to control the quantum bit array.

9. The control device according to claim 1, wherein
a calibration support command obtained by selectively acquiring contents of one of output signals from the quantum bit array is supported.

10. The control device according to claim 1, wherein
when a bit width of a control parameter referenced by a command is equal to or smaller than a bit width defined in the command format of the command, when frequency of calibration demanded for the control parameter is low to a certain extent, or when calibration of the control parameter is deterred, the immediate value is employed as the control parameter, and
if not, a reference destination in the parameter memory regarding the control parameter is set in the command.

11. The control device according to claim 1,
the control device includes means that selects any of a small number of candidate values on a basis of the immediate value set in a command before execution of the command when it is sure to a certain extent that a control parameter referenced by the command is any of the candidate values.

12. The control device according to claim 1, wherein
a control parameter referenced by a command is calculated as a sum of an offset value set in an offset register and a parameter difference value with respect to the offset value, the parameter difference value being set in a difference parameter memory.

13. The control device according to claim 12, wherein
a bit width of the offset register is equal to or larger than a maximum bit width in all of the control parameters referenced from each command supported by the control device, and
a bit width of a parameter difference value stored in each entry of the difference parameter memory is smaller than a bit width of a control parameter stored in each entry of the parameter memory.

14. The control device according to claim 12, wherein
a difference in the offset value between before and after calibration is limited to be equal to or smaller than a maximum variation width permitted in one time of calibration in calibration control of the control parameter.

15. The control device according to claim 12, wherein
the control device includes means that sets a policy for executing calibration in such a manner that a difference in a control parameter value between before and after the calibration is divided into a calibration amount for the offset value and a calibration amount for the parameter difference value in calibration control of the control parameter.
